(19) United States
(12) Patent Application Publication
(10) Pub. No.: US 2016/0261729 A1
(43) Pub. Date: Sep. 8, 2016

(54) FILTER MODULE

(71) Applicant: WISOL CO., LTD., Osan-si (KR)

(72) Inventor: Kyung Sik KIM, Anyang-si (KR)

(21) Appl. No.: 15/061,268

(22) Filed: Mar. 4, 2016

(30) Foreign Application Priority Data
Mar. 5, 2015 (KR) 10-2015-0031166

(51) Int. Cl. H04M 1/02

(52) U.S. Cl. CPC H04M 1/0274; H04W 88/02

(57) ABSTRACT

The present invention relates to a filter module including a substrate, a first filter arranged on the substrate and having an input terminal and an output terminal, a second filter arranged on the substrate and having an input terminal and an output terminal, a single input port connected to the input terminal of the first filter and the input terminal of the second filter, and a single output port connected to the output terminal of the first filter and the output terminal of the second filter.

### BACKGROUND OF THE INVENTION

1. Field of the Invention

The present invention relates to a filter module, and more specifically, to a filter module mounted on a mobile communication terminal and capable of processing a signal transmitted and received according to various frequencies, and the mobile communication terminal on which such a filter module is mounted.

2. Description of the Related Art

The mobile communication field has currently reached LTE-A by way of 3G and 4G (LTE), and next generation communication techniques are discussed continuously.

In the LTE-A, which is a fourth generation mobile communication technique, a multi carrier method, a carrier aggregation method and the like are proposed, adopted and utilized to improve data transmission speed compared with that of LTE.

The multi carrier method is a technique in which a mobile communication terminal connects to a faster frequency among two (a plurality of) frequencies and transmits and receives data. For example, although most of mobile communication terminals of mobile communication company A connect to 850 MHz, which is the main frequency, they switch to another frequency of 1.8 GHz band if too many mobile communication terminals connect to this frequency band and data transmission speed is lowered. It physically means that the bandwidth of a communication network is doubled.

The carrier aggregation method is joining two frequencies that each communication company has. For example, it is simultaneously connecting to the frequencies of 850 MHz and 2.1 GHz used by communication company A and using the maximum speed of each of the frequencies. An LTE frequency may download about 9.3 MB of data per second at a speed of maximum 75 Mbps, and if two of the frequencies are aggregated, the speed is increased to about 18.7 MB at a speed of maximum 150 Mbps. Since each channel actually cannot attain the maximum speed in a communication network, the actual speed can be considerably faster although the speed not doubled.

An antenna and a filter for processing each of the bands (850 MHz and 2.1 GHz in the above example) are needed to apply the carrier aggregation described above. FIG. 1 is a view showing an embodiment of a conventional filter module. Conventionally, each filter is connected to different input and output ports, and a plurality of input ports is selectively connected to the antenna by a switch. A plurality of output ports is also selectively connected to the internal configuration of a mobile communication terminal by a switch.

The conventional method needs a switching element in addition to the filter, and when the switching element is added to the mobile communication terminal, there is a problem in that the size of the mobile communication terminal increases due to the size of the switching element. Furthermore, it is a quite difficult matter to control the switching element in order to precisely execute the carrier aggregation.

### SUMMARY OF THE INVENTION

Therefore, the present invention has been made in view of the above problems, and it is an object of the present invention to miniaturize a filter module mounted on a mobile communication terminal.

In addition, another object of the present invention is to provide a filter module which can effectively implement a carrier aggregation function.

To accomplish the above objects, according to one aspect of the present invention, there is provided a filter module including a substrate, a first filter arranged on the substrate and having an input terminal and an output terminal, a second filter arranged on the substrate and having an input terminal and an output terminal, a single input port connected to the input terminal of the first filter and the input terminal of the second filter, and a single output port connected to the output terminal of the first filter and the output terminal of the second filter.

At this point, the first filter and the second filter may have pass band characteristics different from each other, and a pass band of the first filter and a pass band of the second filter may not interfere with each other. The first filter and the second filter described above may be implemented using a band pass filter. In an embodiment of the present invention, the first filter and the second filter may be connected in parallel between the single input port and the single output port. In addition, the first filter and the second filter may successively pass a signal input into the single input port.

The substrate of the filter module described above may be formed as a multilayer substrate, and, at this point, an impedance matching circuit may be formed inside the multilayer substrate, and the impedance matching circuit may be formed between layers of the multilayer substrate.

A filter module according to another embodiment of the present invention may include a substrate, first to n-th filters (n is an integer equal to or greater than 3) arranged on the substrate and respectively having an input terminal and an output terminal, a single input port connected to the input terminals of the first to n-th filters, and a single output port connected to the output terminals of the first to n-th filters.

A filter module according to another embodiment of the present invention may include a substrate, a first filter arranged on the substrate and having an input terminal and an output terminal, a second filter arranged on the substrate and having an input terminal and an output terminal, a single input port connected to the input terminal of the first filter and the input terminal of the second filter, and a plurality of output ports respectively connected to the output terminal of the first filter and the output terminal of the second filter. At this point, the plurality of output ports may be selectively connected to an external circuit by a switching element included in a device on which the filter module is mounted.

A filter module according to another embodiment of the present invention may include a substrate, first to n-th filters (n is an integer equal to or greater than 3) arranged on the substrate and respectively having an input terminal and an output terminal, a single input port connected to the input terminals of the first to n-th filters, and a plurality of output ports respectively connected to the output terminals of the first to n-th filters.

Meanwhile, the present invention includes a mobile communication terminal including a plurality of antennas, and a filter module connected to the antennas, in which the filter module includes a substrate, a first filter arranged on the substrate and having an input terminal and an output terminal, a second filter arranged on the substrate and having an input terminal and an output terminal, a single input port connected to the input terminal of the first filter and the input terminal of the second filter, and a single output port connected to the output terminal of the first filter and the output terminal of the second filter. The mobile communication terminal may further include an impedance matching circuit connected to at least any one of the single input port and the single output port.

### BRIEF DESCRIPTION OF THE DRAWINGS

FIG. 1 is a block diagram showing an example of a conventional filter module.

FIGS. 2 to 5 are block diagrams showing filter modules according to various embodiments of the present invention.

### DETAILED DESCRIPTION OF THE PREFERRED EMBODIMENT

Hereinafter, a filter module according to the present invention will be described in detail with reference to accompanying drawings. The disclosed embodiments are provided to enable those skilled in the art to easily understand the scope of the present invention, and the present invention is not limited by such embodiments. Moreover, matters illustrated in the drawings are schematized in order to describe or explain the embodiments of the present invention more easily, and hence, may be different from forms embodied actually.

Meanwhile, the expression of ‘including’ an element is an expression of an ‘open type’ which merely refers to existence of a corresponding component, and it should not be construed as precluding additional components.

In addition, the expression such as ‘a first, a second’ or the like is used only for the purpose of distinguishing a plurality of configurations and do not limit the sequences or other features of the configurations.

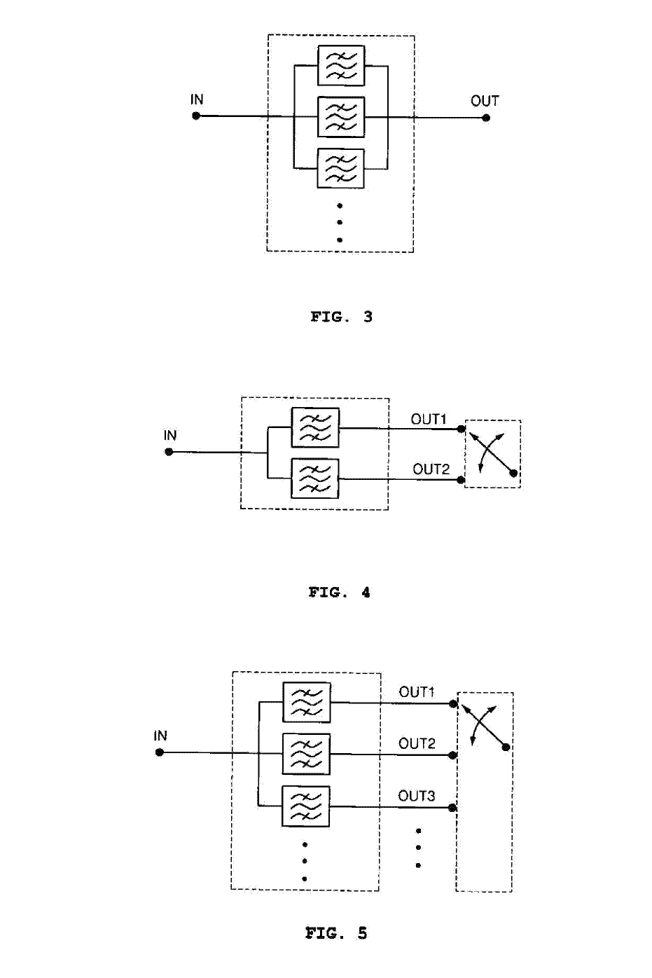

FIG. 2 is a block diagram showing a filter module according to an embodiment of the present invention.

A filter module according to this embodiment includes a substrate, a first filter arranged on the substrate and having an input terminal and an output terminal, a second filter arranged on the substrate and having an input terminal and an output terminal, a single input port connected to the input terminal of the first filter and the input terminal of the second filter, and a single output port connected to the output terminal of the first filter and the output terminal of the second filter.

A piezoelectric substrate, a PCB, a ceramic substrate or the like capable of mounting electronic elements such as a filter can be used as the substrate. On the substrate, the first filter and the second filter which will be described below are mounted, and input ports and output ports are formed, and, in addition, wiring or the like for electrically connecting various configurations mounted or formed on the substrate can be printed.

A filter module according to this embodiment includes a first filter and a second filter. The first filter and the second filter respectively having an input terminal and an output terminal are arranged on the substrate. The first and second filters are configurations for filtering signals input into or output from various devices on which the filter module is mounted. For example, when the filter module of the present invention is mounted on a mobile communication terminal, various communication signals including signals of 2G, 3G, 4G, GPS, Bluetooth, Wi-Fi and the like can be filtered by the filter. In another embodiment which will be described below, the first and second filters may process communication signals of various bands including B1 and B2 even in a 4G network.

The filters, for example, can be implemented by various filters such as a Surface Acoustic Wave (SAW) filter and notch filter, and if a filter can perform the functions described below, its type is not limited. The filters can be arranged on the substrate in a variety of methods such as surface Mount Technology, ultrasonic welding, adhesion and the like.

The input port of the present invention is a passage of the filter module for receiving external signals. For example, the input port is directly or indirectly connected to the antenna of a device on which the filter module is mounted to receive a signal (e.g., a 3G or 4G mobile communication signal) from the antenna and input the signal into the first filter and the second filter. In addition, when the signal processed in the device on which the filter module is mounted is transmitted outside, the signal passing through the filter module can be transmitted to the outside of the device through the input port. The output port of the present invention is a passage for transmitting the signal filtered by the first filter and the second filter to the inside of the device on which the filter module is mounted.

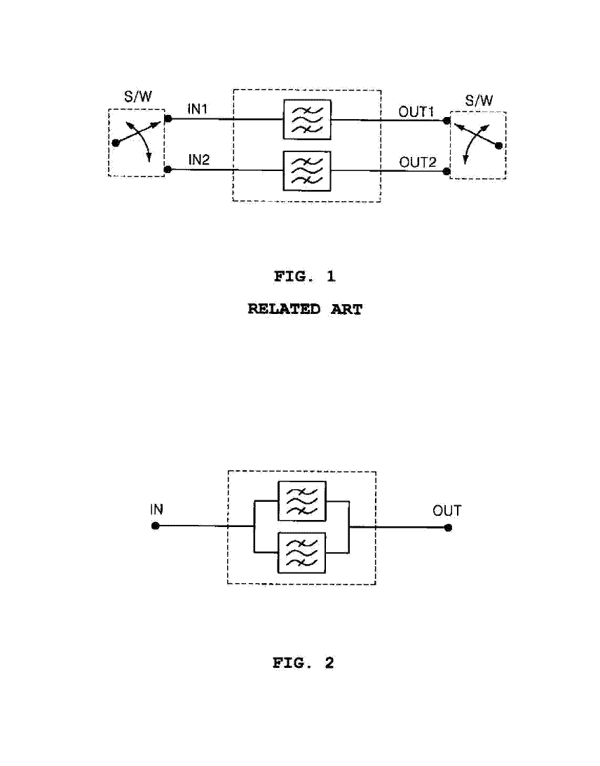

In the present invention, the input port and the output port are respectively formed as a single input port and a single output port. Referring to FIG. 2, it can be confirmed that the input terminal of the first filter and the input terminal of the second filter are commonly connected to the single input port and share the single input port. Before the present invention, each filter mounted in the filter module uses an input port and an output port different from those of the other filters as shown in FIG. 1. In addition, a plurality of input ports is selectively connected to the outside by a switch arranged inside or outside the filter module.

However, since the present invention simultaneously transmits a signal to a plurality of filters through the ‘single’ input port, the switch can be omitted unlike the convention filter module. As a result, the size of the filter module itself can be reduced since the number of input ports and output ports can be reduced, and, in addition, the device can also be miniaturized since the switch can be omitted from the device on which the filter module is mounted. Meanwhile, although the switch needs to be controlled in the conventional filter module in order to efficiently drive the filter module, it does not need to control the switch in the structure of the present invention, and thus various signals can be processed rapidly and accurately. On the other hand, the output port also can be formed as a ‘single’ output port in this embodiment. Accordingly, an effect the same as that of forming the input port as a single input port can be expected.

In another embodiment of the present invention, the first filter and the second filter may have pass band characteristics different from each other. The first filter and the second filter may pass different signals among the various kinds of signals described above. According to this, various mobile communication signals can be processed by one filter module. For example, a 3G signal and a 4G signal can be processed by one filter module, and the filter module may also process a GPS signal and a 4G signal. Particularly, in an embodiment which will be described below, pass bands can be determined so that the first filter and the second filter may pass specific band signals different from each other among 4G band signals, and carrier aggregation can be implemented through this feature.

In another embodiment of the present invention, the pass band of the first filter and the pass band of the second filter may not interfere with each other. Accordingly, although a signal is input into the filter module by the single input port, each filter may transmit and receive the signal to be independent from each other. As a result, transmission characteristics and transmission efficiency of the signal processed by each filter in the filter module can be improved.

In another embodiment of the present invention, the first filter and the second filter can be implemented using a band pass filter. Accordingly, a communication signal of a specific band needed to implement a function in a device on which the filter module is mounted can be efficiently selected and used.

In another embodiment of the present invention, the first filter and the second filter may be connected in parallel between the single input port and the single output port. As shown in FIG. 2, the first filter and the second filter may be arranged in a parallel structure by directly connecting the first filter and the second filter to the single input port and the single output port. In addition, even when other configurations are further included in the filter module, the first filter and the second filter may be connected in parallel between the single input port and the single output port. For example, an amplifier such as a low noise amplifier (LNA) can be further included in the filter module, and even in this case, the first filter and the second filter may be connected in parallel between the single input port and the single output port. Specifically, the LNA may be connected to the first filter in series, and the first filter and the LNA connected in series may be connected to the second filter in parallel. On the contrary, the first filter and the second filter may be connected in parallel after the LNA is connected to the first filter. Alternatively, the first filter and the second filter may be connected in parallel, and the LNA may be connected in series between the first and second filters connected in parallel and the single input port or the single output port. In this embodiment, if the first and second filters are arranged in a parallel structure between the single input port and the single output port, although other components are further included in the filter module and the first and second filters are connected to the input port or the output port by way of the other components, this should be regarded as being included in the structure described in this embodiment.

In another embodiment of the present invention, the first filter and the second filter may successively pass a signal input into the single input port. According to this embodiment, the carrier aggregation function can be effectively implemented.

In the structure as shown in FIG. 1, it needs to precisely control the switch at an appropriate time point in order to execute the carrier aggregation. However, it is very difficult to control the switching so as to simultaneously use bandwidths different from each other, and signal transmission using the carrier aggregation is impossible or transmission efficiency is extremely lowered if only a slight error occurs in the switching control.

However, if the first filter and the second filter are activated at all times as shown in the present invention and the first filter and the second filter successively pass a signal input into the single input port, the carrier aggregation function can be implemented without controlling the switch. Accordingly, signal transmission quality, as well as signal transmission speed, can be improved.

In an embodiment of the present invention, the substrate may be a multilayer substrate, and an impedance matching circuit can be formed inside the multilayer substrate. Particularly, the impedance matching circuit can be formed between the layers of the multilayer substrate. Conventionally, the impedance matching circuit for improving transmission efficiency of the filter module is formed on the substrate together with a filter. However, in such a structure, a space for arranging the impedance matching circuit is needed on the substrate.

However, in this embodiment, since the impedance matching circuit is not arranged on the substrate, but formed inside the multilayer substrate, a separate area for arranging the impedance matching circuit does not need to be allocated on the surface of the substrate. Accordingly, the size of the filter module can be reduced compared with the conventional structure. Therefore, a filter module meeting the requirement of a mobile communication device miniaturized day by day can be manufactured.

FIG. 3 is a block diagram showing a filter module according to another embodiment of the present invention.

A filter module according to this embodiment includes a substrate, first to n-th filters (n is an integer equal to or greater than 3) arranged on the substrate and respectively having an input terminal and an output terminal, a single input port connected to the input terminals of the first to n-th filters, and a single output port connected to the output terminals of the first to n-th filters.

In this embodiment, a large number of filters are included in the filter module compared with the various embodiment described above. However, the various features described in the above embodiments may also be applied to this embodiment shown in FIG. 3. For example, the features such that the first to n-th filters have pass band characteristics different from each other, the filters do not interfere with each other, the filters are implemented using a band pass filter, the filters are connected in parallel, the filters successively pass a communication signal, and the filters are form on a multilayer substrate and an impedance matching circuit is formed between the layers of the multilayer substrate can also be applied to the filter module according to this embodiment.

FIG. 4 is a block diagram showing a filter module according to another embodiment of the present invention.

A filter module according to this embodiment includes a substrate, a first filter arranged on the substrate and having an input terminal and an output terminal, a second filter arranged on the substrate and having an input terminal and an output terminal, a single input port connected to the input terminal of the first filter and the input terminal of the second filter, and a plurality of output ports respectively connected to the output terminal of the first filter and the output terminal of the second filter.

Unlike the filter module described above with reference to FIG. 2, in this embodiment, the input port is formed as a single input port, and the output port is formed as a plurality of output ports. Therefore, the filter module is selectively connected to an external circuit configured inside a device on which the filter module is mounted, and a signal filtered by the filter module can be selectively transmitted to the external circuit.

In another embodiment of the present invention, a filter module may include a substrate, first to n-th filters (n is an integer equal to or greater than 3) arranged on the substrate and respectively having an input terminal and an output terminal, a single input port connected to the input terminals of the first to n-th filters, and a plurality of output ports respectively connected to the output terminals of the first to n-th filters. This is shown in FIG. 5.

The various features described above may also be applied to the structure according to the embodiment described with reference to FIGS. 4 and 5. For example, the features such that the first to n-th filters have pass band characteristics different from each other, the filters do not interfere with each other, the filters are implemented by a band pass filter, the filters are connected in parallel, the filters successively pass a communication signal, and the filters are form on a multilayer substrate and an impedance matching circuit is formed between the layers of the multilayer substrate can also be applied to the filter module according to this embodiment.

The present invention also includes a mobile communication terminal to which the embodiments described above are applied, and the mobile communication terminal includes a plurality of antennas and a filter module connected to the antennas, and the filter module may include a substrate, a first filter arranged on the substrate and having an input terminal and an output terminal, a second filter arranged on the substrate and having an input terminal and an output terminal, a single input port connected to the input terminal of the first filter and the input terminal of the second filter, and a single output port connected to the output terminal of the first filter and the output terminal of the second filter.

In this case, the filter module may further include an impedance matching circuit connected to at least any one of the single input port and the single output port, and signal interference can be reduced as a result.

According to the present invention, since a switching element can be omitted, the filter module can be miniaturized. Accordingly, the size of a mobile communication terminal on which the filter module is mounted can also be reduced. More specifically, since an impedance matching circuit is not arranged on the substrate, but formed inside a multilayer substrate, a separate area for arranging the impedance matching circuit does not need to be allocated on the surface of the substrate, and thus the size of the filter module can be reduced compared with the conventional structure.

The present invention may efficiently implement carrier aggregation without a precise switching control. More specifically, since the pass band of the first filter and the pass band of the second filter may not interfere with each other, each filter may transmit and receive a signal to be independent from each other although the signal is input into the filter module through the single input port, and, as a result, transmission characteristics and transmission efficiency of the signal processed by each filter in the filter module can be improved.

According to the present invention, since the first filter and the second filter can be implemented using a band pass filter, a communication signal of a specific band needed to implement a function in a device on which the filter module is mounted can be efficiently selected and used.

The embodiments of the present invention described above are disclosed for illustrative purposes, and the present invention is not to be restricted by the embodiments. In addition, those skilled in the art can make diverse changes and modifications within the spirit and scope of the present invention, and those changes and modifications should be regarded as being included within the scope of the present invention.

What is claimed is:

1. A filter module comprising:
a substrate;
a first filter arranged on the substrate and having an input terminal and an output terminal;
a second filter arranged on the substrate and having an input terminal and an output terminal;
a single input port connected to the input terminal of the first filter and the input terminal of the second filter, and
a single output port connected to the output terminal of the first filter and the output terminal of the second filter.

2. The filter module according to claim 1, wherein the first filter and the second filter have pass band characteristics different from each other.

3. The filter module according to claim 1, wherein a pass band of the first filter and a pass band of the second filter do not interfere with each other.

4. The filter module according to claim 1, wherein the first filter and the second filter are band pass filters.

5. The filter module according to claim 1, wherein the first filter and the second filter are connected in parallel between the single input port and the single output port.

6. The filter module according to claim 1, wherein the first filter and the second filter successively pass a signal input into the single input port.

7. The filter module according to claim 1, wherein the substrate is a multilayer substrate.

8. The filter module according to claim 7, wherein an impedance matching circuit is formed inside the multilayer substrate.

9. The filter module according to claim 8, wherein the impedance matching circuit is formed between layers of the multilayer substrate.

10. A filter module comprising:
a substrate;
first to n-th filters (n is an integer equal to or greater than 3) arranged on the substrate and respectively having an input terminal and an output terminal;
a single input port connected to the input terminals of the first to n-th filters; and
a single output port connected to the output terminals of the first to n-th filters.

11. A filter module comprising:
a substrate;
a first filter arranged on the substrate and having an input terminal and an output terminal;
a second filter arranged on the substrate and having an input terminal and an output terminal;
a single input port connected to the input terminal of the first filter and the input terminal of the second filter; and
a plurality of output ports respectively connected to the output terminal of the first filter and the output terminal of the second filter.

12. The filter module according to claim 11, wherein the plurality of output ports is selectively connected to an external circuit by a switching element.

13. A filter module comprising:
a substrate;
first to n-th filters (n is an integer equal to or greater than 3) arranged on the substrate and respectively having an input terminal and an output terminal;
a single input port connected to the input terminals of the first to n-th filters; and
a plurality of output ports respectively connected to the output terminals of the first to n-th filters.

14. A mobile communication terminal comprising:
a plurality of antennas; and
a filter module connected to the antennas, wherein the filter module includes:
a substrate;
a first filter arranged on the substrate and having an input terminal and an output terminal;
a second filter arranged on the substrate and having an input terminal and an output terminal;
a single input port connected to the input terminal of the first filter and the input terminal of the second filter; and
a single output port connected to the output terminal of the first filter and the output terminal of the second filter.

15. The terminal according to claim 14, further comprising an impedance matching circuit connected to at least any one of the single input port and the single output port.
